(19) United States
(12) Patent Application Publication
(10) Pub. No.: US 2025/0007668 A1
(43) Pub. Date: Jan. 2, 2025

(54) HYBRID AUTOMATIC REPEAT REQUEST (HARQ) RELATED APPROACHES TO MITIGATE THE IMPACT OF INTERFERENCE

(71) Applicant: INTERDIGITAL PATENT HOLDINGS, INC., Wilmington, DE (US)

(72) Inventors: Tariq Elkourdi, Belleville, NJ (US); Paul Russell, Lawrence, NJ (US); Joseph Murray, Schwenksville, PA (US); Muhammad Fazili, Audubon, PA (US); Alpaslan Demir, East Meadow, NY (US); Philip Pietraski, Jericho, NY (US); Sudhir Pattar, Mount Laurel, NJ (US); Joe Huang, Montville, NJ (US); Patrick Cabrol, Bayshore, NY (US)

(73) Assignee: INTERDIGITAL PATENT HOLDINGS, INC., Wilmington, DE (US)

(21) Appl. No.: 18/697,146

(22) PCT Filed: Sep. 29, 2022
(86) PCT No.: PCT/US2022/045195

§ 371 Date: Mar. 29, 2024

Related U.S. Application Data
(60) Provisional application No. 63/294,889, filed on Dec. 30, 2021.
(60) Provisional application No. 63/391,497, filed on Jul. 22, 2022.

(51) Int. Cl. H04L 5/00; H04L 1/1812

(52) U.S. Cl. CPC H04L 5/0053; H04L 1/1812

(57) ABSTRACT

A method performed by a base station may compromise: detecting an interference pattern; determining that the interference pattern impacts one or more code blocks (CBs) within one or more code block groups (CBGs); adjusting a size of the one or more CBGs; and transmitting, to a wireless transmit/receive unit (WTRU), information associated with the adjusting of the size of the one or more CBGs. The interference pattern may be caused by a radio detection and ranging (RADAR) system. The adjusting of the size of the one or more CBGs may compromise increasing or decreasing the number of CBs within the one or more CBGs. The transmitting of the information relating to the adjusting of the size of the one or more CBGs may be performed via master information block (MIB) signaling, radio resource control (RRC) signaling, or downlink control information (DCI) signaling.

### CROSS-REFERENCE TO RELATED APPLICATIONS

This application claims the benefit of U.S. Provisional Application No. 63/249,889, filed Sep. 29, 2021, and U.S. Provisional Application No. 63/391,497, filed Jul. 22, 2022 the contents of which are incorporated herein by reference.

### BACKGROUND

Automatic Repeat Request (ARQ) is an error control technique that relies on retransmissions but discards erroneously received data. This can lead to a decrease in ARQ efficiency. Hybrid ARQ (HARQ), takes advantage of these erroneous packets by storing them in a buffer memory and combining them to obtain the original transmitted data. HARQ, paired with multiple stop-and-wait transmission protocol, is a powerful error correction mechanism that does not throttle throughput as opposed to single stop-and-wait protocol.

In recent communication systems, the need for asynchronous HARQ for both uplink and downlink has become paramount because it allows for dynamic TDD as well as operation in unlicensed spectrum. Furthermore, it is typical for cellular systems to support multiple HARQ processes. For example, LTE supports up to 8 multiple HARQ processes for FDD and up to 15 for TDD whereas in 5G New Radio supports a maximum of 16 multiple HARQ processes.

### SUMMARY

A method performed by a wireless transmit/receive (WTRU) unit may compromise: receiving, from a base station, a first downlink control information (DCI) indicating a first code block group (CBG) size; receiving, from the base station, a transport block (TB) that includes one or more CBGs, wherein the one or more CBGs include one or more code blocks (CBs); performing a cyclic redundancy check (CRC) on the received TB; transmitting, to the base station, feedback based on the CRC; and receiving, from the base station, a second DCI indicating a second CBG size, wherein the second CBG size is based on the transmitted feedback. The feedback may be an acknowledgement (ACK) or a negative acknowledgement (NACK). If the feedback is an ACK, the second CBG size may be larger than the first CBG size. If the feedback is a NACK, the second CBG size may be smaller than the first CBG size.

A method performed by a base station may compromise: detecting an interference pattern; determining that the interference pattern impacts one or more code CBs within one or more CBGs; adjusting a size of the one or more CBGs; and transmitting, to a WTRU, information associated with the adjusting of the size of the one or more CBGs. The interference pattern may be caused by a radio detection and ranging (RADAR) system. The adjusting of the size of the one or more CBGs may compromise increasing the number of CBs within the one or more CBGs. The adjusting of the size of the one or more CBGs may compromise decreasing the number of CBs within the one or more CBGs. The interference pattern may impact the same CB instance in each CBG. The base station may detect the interference pattern based on feedback from one or more WTRUs.

The transmitting of the information relating to the adjusting of the size of the one or more CBGs may be performed via master information block (MIB) signaling. The transmitting of the information relating to the adjusting of the size of the one or more CBGs may be performed via radio resource control (RRC) signaling. The RRC signaling may include information indicating a CBG sizing duration. The transmitting of the information relating to the adjusting of the size of the one or more CBGs may be performed via downlink control information (DCI) signaling.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example downlink retransmission of CBGs;

FIG. 3 is a diagram illustrating an example PUSCH HARQ feedback timing;

FIG. 4 is a diagram illustrating an example PDSCH HARQ feedback timing;

FIG. 5 is a diagram illustrating an example dynamic code block regrouping used to adjust the size of the transmitted CBGs based on the presence of interference;

FIG. 6 is a diagram illustrating an example dynamic code block regrouping used to adjust the size of the transmitted CBGs based on the presence of interference;

FIG. 7 is a diagram illustrating an example code block segmentation, filler insertion, CRC insertion and CB grouping;

FIG. 8 is a diagram illustrating an example process of CBG sizing according to an embodiment;

FIG. 9 is a diagram illustrating an example of an RRC configured CBG sizing;

FIG. 10 is a diagram illustrating an example of when interleaving is applied and all CBGs will need to be retransmitted; and

FIG. 11 is a diagram illustrating an example of when interleaving is applied and CBG #1 and CBG #3 are error free and will not need to be re-transmitted; and

FIG. 12 is a diagram illustrating an example process of CBG sizing according to an embodiment.

### DETAILED DESCRIPTION

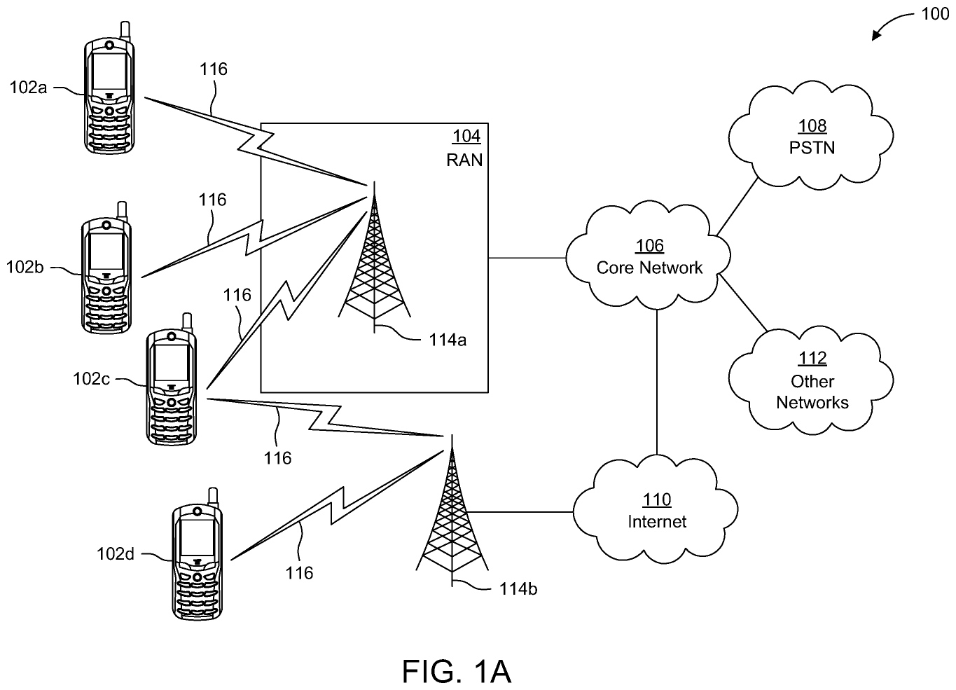

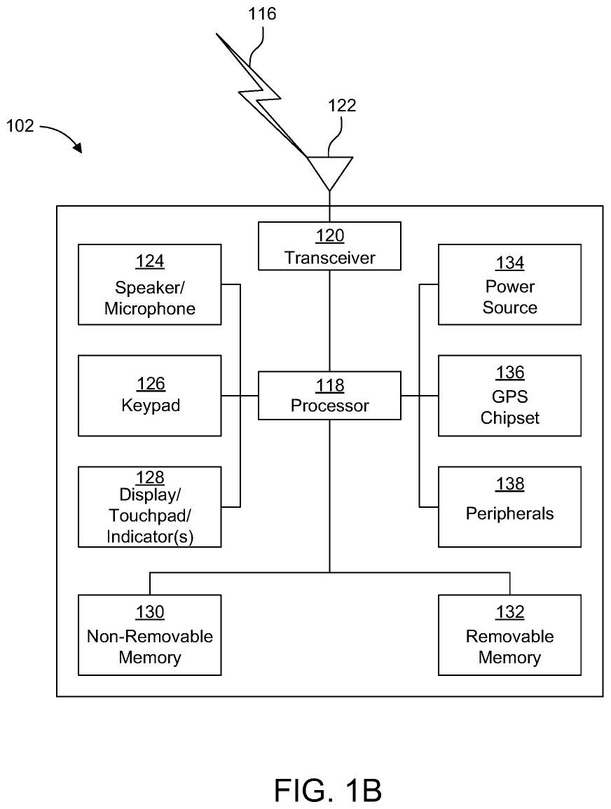

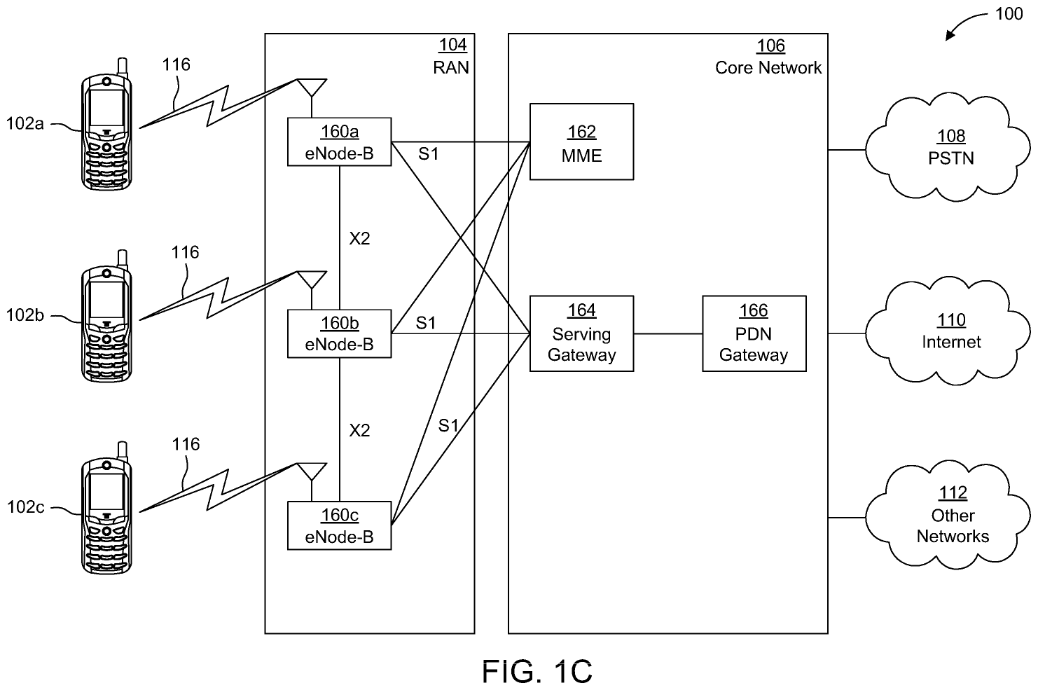

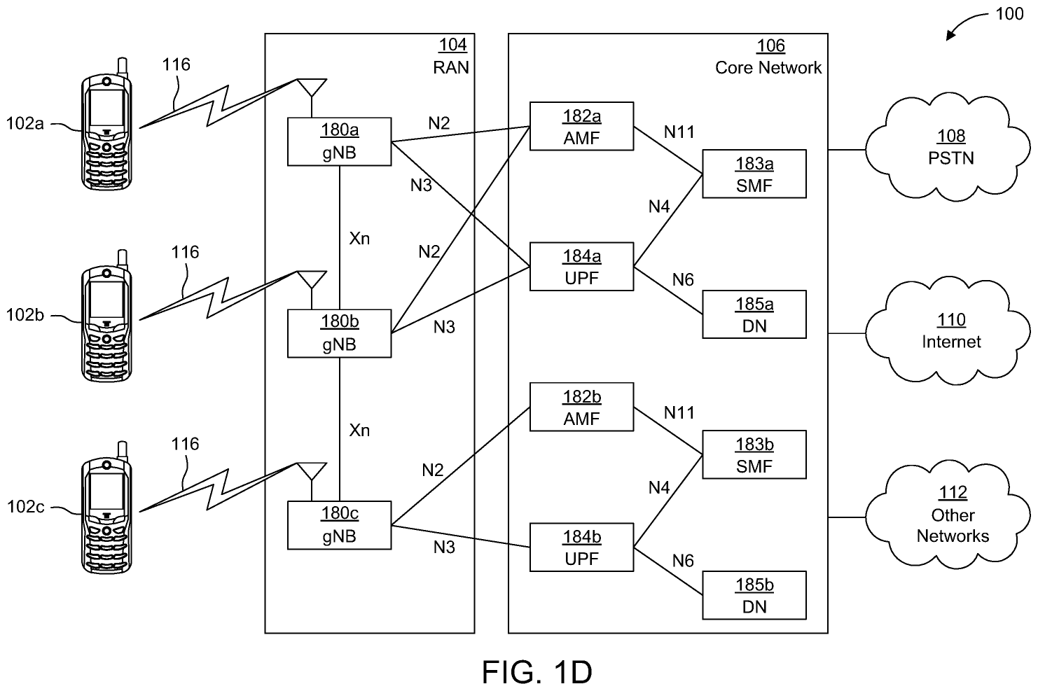

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

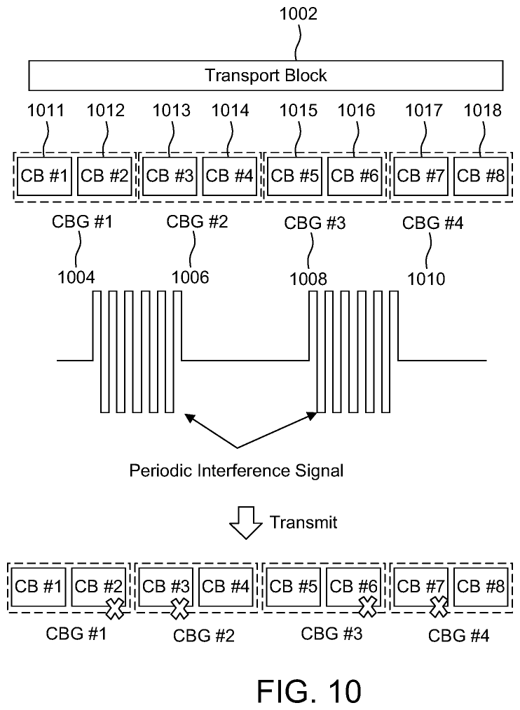

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviation and acronyms may be referred to:

| | |
|---|---|
| 3GPP | Third Generation Partnership Project |
| 5G | 5th Generation |
| ARQ | Automatic Repeat Request |
| BW | Bandwidth |
| BWP | Bandwidth Part |
| CB | Code Block |
| CBG | Code Block Group |
| CBGFI | CBG Flushing Out Information |
| CBGTI | Code Block Group Transmit Indicator |
| CCE | Control Channel Element |
| CORESET | Control Resource Set |
| CRB0 | Common Resource Block |
| CRC | Cyclic Redundancy Check |
| DCI | Downlink Control Information |
| DL | Downlink |
| DMRS | Demodulation Reference Signal |
| DMRS | De-Modulation Reference Symbol |
| FDD | Frequency Division Duplex |
| gNB | gNodeB |
| HARQ | Hybrid Automatic Repeat Request |
| MAC | Medium Access Control |
| MIB | Master Information Block |
| NR | New Radio |
| NSA | Non-Stand Alone |
| OFDM | Orthogonal Frequency Division Multiplexing |
| PBCH | Physical Broadcast Channel |
| PDCCH | Physical Downlink Control Channel |
| PDCCH | Physical DL Control Channel |
| PDSCH | Physical Downlink Shared Channel |
| PHY | Physical Layer |
| PRACH | Physical Random Access Channel |
| PSS | Primary Synchronization Sequence |
| PUSCH | Physical Uplink Share Control Channel |
| RADAR | Radio Detection and Ranging |
| RB | Resource Block |
| RE | Resource Element |
| REG | Resource Element Group |
| RRC | Radio Resource Control |
| RV | Redundancy Version |
| SCS | Subcarrier Spacing |
| SI | System Information |
| SIB1 | System Information Block 1 |
| SPS | Semi-Persistent Scheduling |
| SS_PBCH | Synchronization and Broadcast Channel combination |
| SSB | SS/PBCH Block |
| SSS | Secondary Synchronization Sequence |
| TDD | Time Division Duplex |
| UE | User Equipment |
| UL | Uplink |
| WTRU | Wireless Transmit/Receive Unit |

Automatic Repeat Request (ARQ) is an error control technique that relies on retransmissions but discards erroneously received data. This can lead to a decrease in ARQ efficiency. Hybrid ARQ (HARQ), takes advantage of these erroneous packets by storing them in a buffer memory and combining them to obtain the original transmitted data. HARQ, paired with multiple stop-and-wait transmission protocol, is a powerful error correction mechanism that does not throttle throughput as opposed to single stop-and-wait protocol.

In recent communication systems, the need for asynchronous HARQ for both uplink and downlink has become paramount because it allows for dynamic TDD as well as operation in unlicensed spectrum. Also, it is typical for cellular systems to support multiple HARQ processes. For example, LTE may support up to 8 multiple HARQ processes for FDD and up to 15 for TDD whereas 5G may support a maximum of 16 multiple HARQ processes.

There are two primary retransmission combining techniques—chase combining and incremental redundancy. In chase combining, identical replicas of transmitted data bits are sent. In incremental redundancy, combinations of the systematic bits and the parity bits are sent. The first transmission may include all the systematic bits. In 5G, incremental redundancy is used by default with order of redundancy versions set as 0, 1, 2, 3.

Large transport blocks may be appended with CRC and segmented into multiple code blocks (CBs), each appended with its own CRC bits and then grouped into code block groups of two, four, six, or eight CBGs. The number of code blocks in a CBG may depend on the number of CBs in the initial transmission. The size of the CBG is determined by RRC messages. When interference impacts a CB, the entire CBG which contains the CB is retransmitted. The New Data Indicator (NDI) field in DCI is used to indicate whether new data is being transmitted in the uplink or the downlink. This field has a single bit and works in a toggled mode (i.e., toggling indicates new data transmission). Unlike in the downlink, there is no explicit ACK or NACK in the uplink.

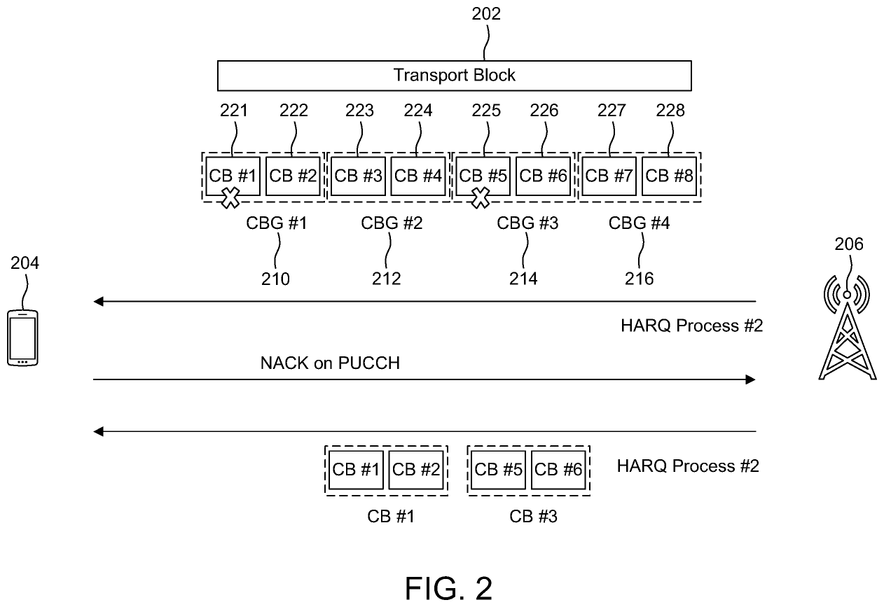

FIG. 2 illustrates an example downlink retransmission of CBGs. As shown in FIG. 2, the transport block 202 includes four CBGs—CBG #1 210, CBG #2 212, CBG #3 214, and CBG #4 216. Each CBG includes two code blocks. CBG #1 210 includes CB #1 221 and CB #2 222, CBG #2 212 includes CB #3 223 and CB #4 224, CBG #3 214 includes CB #5 225 and CB #6 226, and CBG #4 216 includes CB #7 227 and CB #8 228. As shown in FIG. 2, CB #1 221 and CB #5 225 experience interference. The interference may be caused by RADAR.

After the WTRU 204 receives the transport block 202 from the transmitter 206, it sends a NACK 230 to the transmitter 206 because CB #1 221 and CB #5 225 were interfered with. Accordingly, transmitter 206 retransmits CBG #1 210 and CBG #3 214 to the WTRU 204.

If retransmissions are configured per CBG, the receiver needs information on which CBGs are retransmitted and when to flush its buffer. This is handled via DCI fields Code Block Group Transmit Indicator (CBGTI) and Code Block Group Flush Indicator (CBGFI). CBGTI is a bitmap that indicates which CBG is being (re) transmitted in the downlink. The CBGFI may be indicated by a single bit, where “1” may indicate a flush command and “0” may indicate that soft combing should be done. In the uplink, HARQ ACK and NACK can be multiplexed with SR or CRI over PUCCH or with data over PUSCH.

HARQ timing may be indicated by a three-bit field in DCI and may represent the ACK timing in the uplink relative to PDSCH reception. HARQ timing may point to a value in a RRC configured table. RRC parameter K0 may indicate the slot offset in which downlink data scheduled. It may range from 0 to 32 slots. The WTRU send UL acknowledgement after K1 slot offset. The range of K1 is 0 to 15 slots and depends on the WTRU capability. This WTRU capability is given as N1 which consists of PDSCH decoding delay and on the DMRS configuration as indicated in Table 1 and Table 2 below.

TABLE 1
PDSCH Processing Time for PDSCH Processing Capability 1

| | PDSCH Decoding Time N1 [symbols] | |
|---|---|---|
| | | dmrs-AdditionalPosition ≠ pos0 in |
| | dmrs-AdditionalPosition = | DMRS-DownlinkConfig in either |
| | pos0 in DMRS-DownlinkConfig | of dmrs-DownlinkForPDSCH- |
| | in both of | MappingTypeA, dmrs- |
| | dmrs-DownlinkForPDSCH- | DownlinkForPDSCH- |
| | MappingTypeA, dmrs- | MappingTypeB or if |
| | DownlinkForPDSCH- | the high layer parameter |
| μ | MappingTypeB | is not configured |
| 0 | 8 | 13 |
| 1 | 10 | 13 |
| 2 | 17 | 20 |
| 3 | 20 | 24 |

TABLE 2
PDSCH Processing Time for PDSCH Processing Capability 2

| | PDSCH Decoding Time N1 [symbols] |
|---|---|
| | dmrs-AdditionalPosition = pos0 in DMRS- |
| | DownlinkConfig in both of dmrs- |
| | DownlinkForPDSCH-MappingTypeA, dmrs- |
| μ | DownlinkForPDSCH-MappingTypeB |
| 0 | 3 |
| 1 | 4.5 |
| 2 | 9 for FR1 |

Parameter K2 may be the slot offset required from uplink grant to downlink retransmission. The offset may also depend on the WTRU capability indicated as N2 which corresponds to the PUSCH preparation time. The offset may range from 0 to 32 slots. Table 3 below represents values of N2 for PUSCH preparation time for PUSCH timing capability 1. Table 4 below represents values of N2 for PUSCH preparation time for PUSCH timing capability 2.

TABLE 3
PUSCH Preparation Time for PUSCH Timing Capability 1

| μ | PUSCH Preparation Time N2 [symbols] |
|---|---|
| 0 | 10 |
| 1 | 12 |
| 2 | 23 |
| 3 | 36 |

TABLE 4
PUSCH Preparation Time for PUSCH Timing Capability 2

| M | PUSCH Preparation Time N2 [symbols] |
|---|---|
| 0 | 5 |
| 1 | 5.5 |
| 2 | 11 for FR1 |

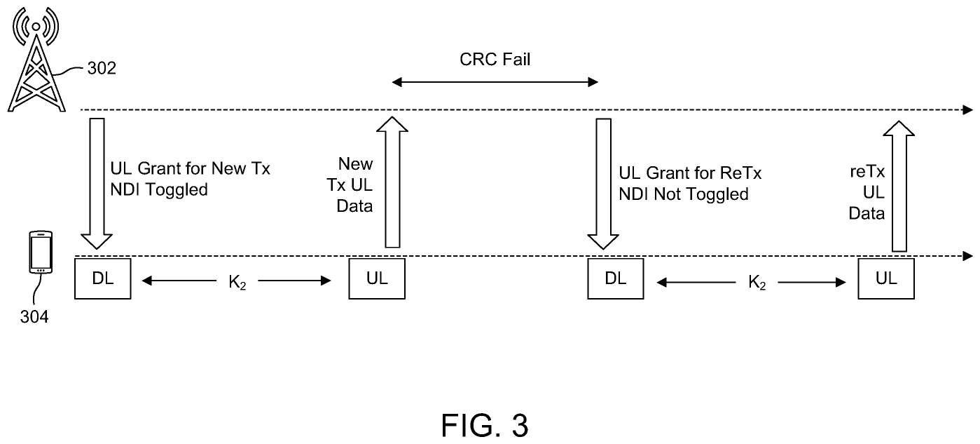

FIG. 3 illustrates an example of PUSCH HARQ feedback timing. As shown in FIG. 3, base station 302 transmits, to a WTRU 304, a UL DCI for UL data scheduling. The UL DCI may indicate that a new UL transmission is granted after K2 slots, where K2 is the offset between the DL slot in which the DCI is received and the UL slot in which the UL data is scheduled to be transmitted via a PUSCH. Next, UL data is transmitted by the WTRU 304 to the base station 302 via a PUSCH. If the UL data is not successfully decoded at the base station 302 (i.e., CRC fail), the base station 302 may transmit, to the WTRU 304, another UL grant for UL data retransmission with New Data Indicator (NDI) bit not toggled and a new K2 value. The same procedure may followed for all subsequent (re)transmissions.

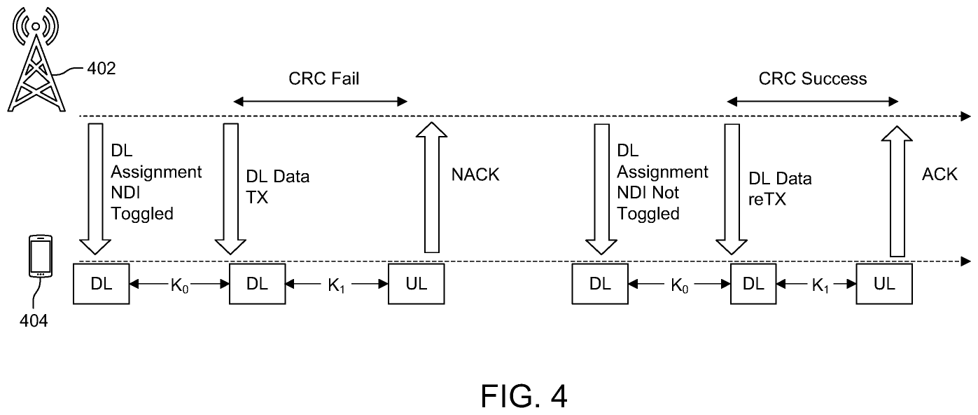

FIG. 4 illustrates an example PDSCH HARQ feedback timing. As shown in FIG. 4, base station 402 transmits, to WTRU 404, a DL DCI for DL data scheduling. The DL DCI may indicate that a new DL transmission is granted after K0 slot, where K0 is the offset between the DL slot in which the DCI for DL scheduling is received and the slot in which the DL data is scheduled to be transmitted via PDSCH. The DCI may also indicates K1 value, which may be the offset between the DL slot in where DL data is scheduled and the UL slot in which corresponding ACK/NACK feedback is expected to be sent. Next, the DL data is received by the WTRU 404 via PDSCH. If the DL data is not successfully decoded at the WTRU 404 (i.e., CRC fail), the WTRU 404 may transmit a NACK after K1 slots indicating unsuccessful decoding. The base station 404 may then transmit another DL DCI for DL data retransmission with NDI bit not toggled and indicate a new K0 value. The same procedure may be followed for all (re)transmissions.

HARQ multiplexing may use multi-bit HARQ feedback message to ACK/NACK multiple transport blocks. There may be two primary approaches to HARQ multiplexing: (1) semi-static codebook and (2) dynamic codebook. The base station may communicate to a WTRU regarding which approach to use via RRC configuration messages. Semi-static codebook is a matrix that maps time instances with component carriers/CBGs/MIMO layers. A semi-static approach may not be optimal for large number of carrier components because large HARQ reports will need to be transmitted.

Dynamic codebook resolves the large report issue as the size of the codebook is dynamically changed. The key idea is that it eliminates the carriers that are not scheduled (i.e., ACK/NACKs feedback is transmitted only for the scheduled carriers) and uses a special indexing technique to keep track of which feedback is for which carrier. This is handled via downlink assignment index (DAI) reported in the downlink assignment DCI. The DAI field has two indices, a counter DAI (cDAI) and a total DAI (tDAI) used for carrier aggregation. The cDAI index indicates the number of DL transmissions up to the time of DCI reception. This indexing happen at the carrier level first and then on the temporal level. The tDAI indicates the total number of DL transmissions on all carriers up to the time of the DCI reception.

With the capability of recent cellular communication systems to operate on higher frequencies, the interference between these systems and other military and civil operations, such as aviation RADAR(s), has become a major concern. Interference from these systems (e.g., RADAR) may hinder the performance of 5G systems which rely heavily on shorter delays and higher throughputs.

For example, in 5G, the number of CBs within a CBG may depend on the initial transmission. Once this number is fixed in the initial transmission, the base station will use the same number for all subsequent retransmissions. A periodic interferer, such as the RADAR, may impact a single CB within the CBG. Upon unsuccessful decoding of the CB, the base station may retransmit the entire CBG, potentially wasting valuable resources. Conversely, smaller CBGs may result in frequent HARQ feedback, leading to inefficiency.

Approaches to mitigate the impact of periodic interference on HARQ performance are disclosed. The base station may detect identify and analyze an interference pattern and may inform a WTRU of a corresponding HARQ approach as described below.

In one embodiment, the transmitter may statically, semi-dynamically, or dynamically change the size of the code block group to either reduce the amount of unnecessary data transmissions or reduce the amount of ACK/NACK feedback. The network may choose to reduce its CBG size to avoid unnecessarily large retransmissions or increase it to avoid frequent HARQ feedback.

Another embodiment may be based on the ability of the base station to recognize patterns of the interferer. This embodiment may utilize CB and/or CBG interleaving techniques to transmit CBGs during interference silence periods. These techniques optimally re-arrange CBs and/or CBGs within a transport block to minimize the impact of interference on transmitted CBGs.

As described above, in one embodiment, the network may change the size of the CBGs based on knowledge of the interference presence and the interference pattern. When an interferer (e.g., RADAR) is present and impacts only a subset of the CBs within a CBG, the network may reduce the size of the CBG such that it contains only the blocks impacted by interference.

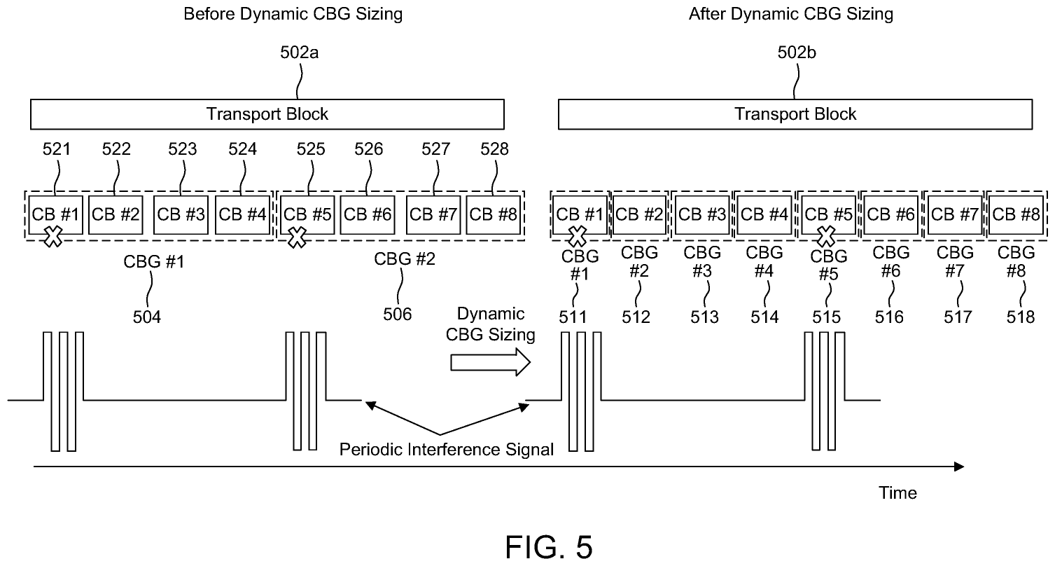

FIG. 5 is a diagram illustrating an example dynamic code block regrouping used to adjust the size of the transmitted CBGs based on the presence of an interference pattern (e.g. RADAR). As shown in FIG. 5, prior to resizing, the transport block 502a includes two CBGs—CBG #1 504 and CBG #2 506. CBG #1 504 and CBG #2 506 each contain four CBs before CBG sizing. CBG #1 504 includes CB #1 521, CB #2, 522, CB #3 523, and CB #4 424. CBG #2 includes CB #5 525, CB #6 526, CB #7 527, and CB #8 528. Further, the periodic signal is interfering with CB #1 421 and CB #5 525. Here, prior to resizing, retransmission of the entire CBG is inefficient and a waste of valuable resources that may be avoided by reducing the size of the CBGs to one CB (i.e., no grouping).

CBG resizing, allows the network to save on the amount of transmitted data by reducing the amount of unnecessary CB retransmissions, thus improving delay and throughput. As shown in FIG. 5, one way to design the transport block 502b may be to resize each CBG to include only one CB. After dynamic CBG sizing, transport block 502b includes eight CBGs—CBG #1 511, CBG #2 512, CBG #3 513, CBG #4 514, CBG #5 515, CBG #6 516, CBG #7 517, and CBG #8 518. Each CBG includes one CB. After dynamic CBG sizing, because each CBG includes only one CB, only CBG #1 511 and CBG #5 515 need to be retransmitted. Conversely, when the interferer is absent, the network may choose to transmit larger CBGs to save on uplink signaling.

The periodic signal may interfere with the same CB instance in each CBG. For example, in FIG. 5, the periodic signal may interfere with the first CB (i.e., CB #1 521 and CB #5 525) in each of the two CBGs (i.e., CBG #1 504 and CBG #2 506).

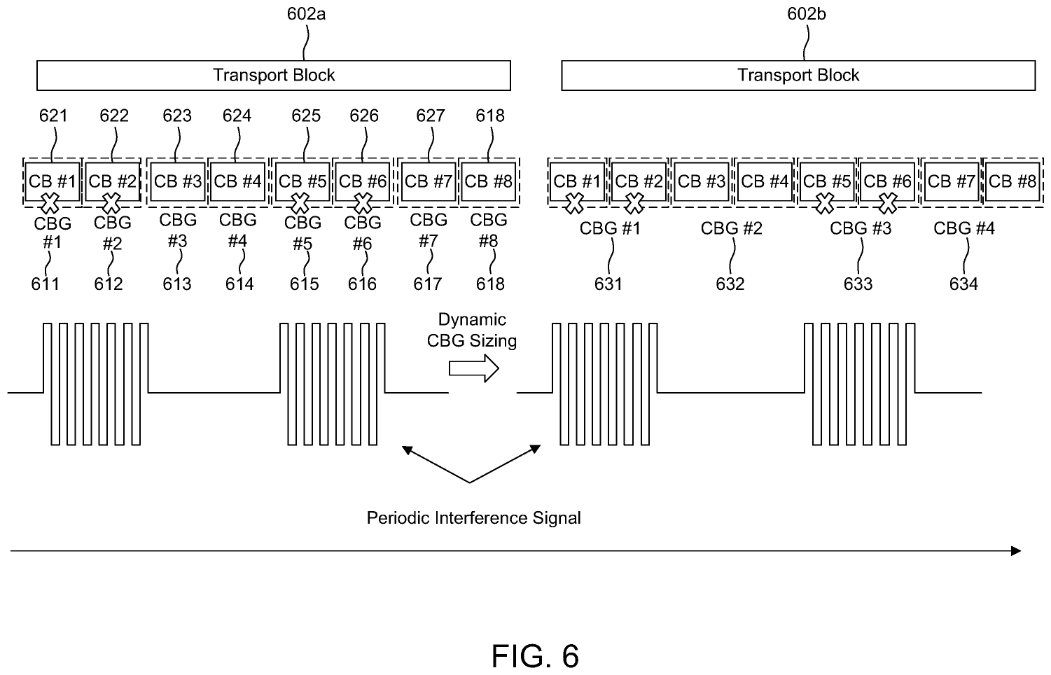

FIG. 6 illustrates another example of dynamic code block regrouping used to adjust the size of the transmitted CBGs based on the presence of interference. As shown in FIG. 6, if the interference pattern impacts a contiguous set of CBs larger than the size of the CBG, the network may increase the size of the CBG such that all impacted CBs are contained within one CBG. In FIG. 6, prior to dynamic CBG sizing, transport block 602a includes eight total CBGs—CBG #1 611, CBG #2 612, CBG #3 613, CBG #4 614, CBG #5 615, CBG #6 616, CBG #7 617, and CBG #8 618. Prior to dynamic CBG sizing, each CBG includes only one CB. CBG #1 611 includes CB #1 621, CBG #2 612 includes CB #2 622, CBG #3 613 includes CB #3 623, CBG #4 614 includes CB #4 624, CBG #5 615 includes CB #5 625, CBG #6 616 includes CB #6 626, CBG #7 617 includes CB #7 627, and CBG #8 618 includes CB #8 628. Here, four CBs are impacted by interference (e.g., RADAR)—CB #1 621, CB #2 622, CBD #5 615, and CBD #6 616.

After dynamic CBG resizing, the transport block 602b includes four CBGs—CBG #1 631, CBG #2 632, CBG #3 633, and CBG #4 634. After resizing, the four impacted CBs are grouped together in two separate CBGs. As shown in FIG. 6, CBG #1 includes CB #1 611 and CB #2 612 and CBG #3 633 includes CB #5 615 and CB #6 626. Grouping the CBs into CBGs of size two allows savings in uplink ACK/NACKs, thus improving uplink metrics.

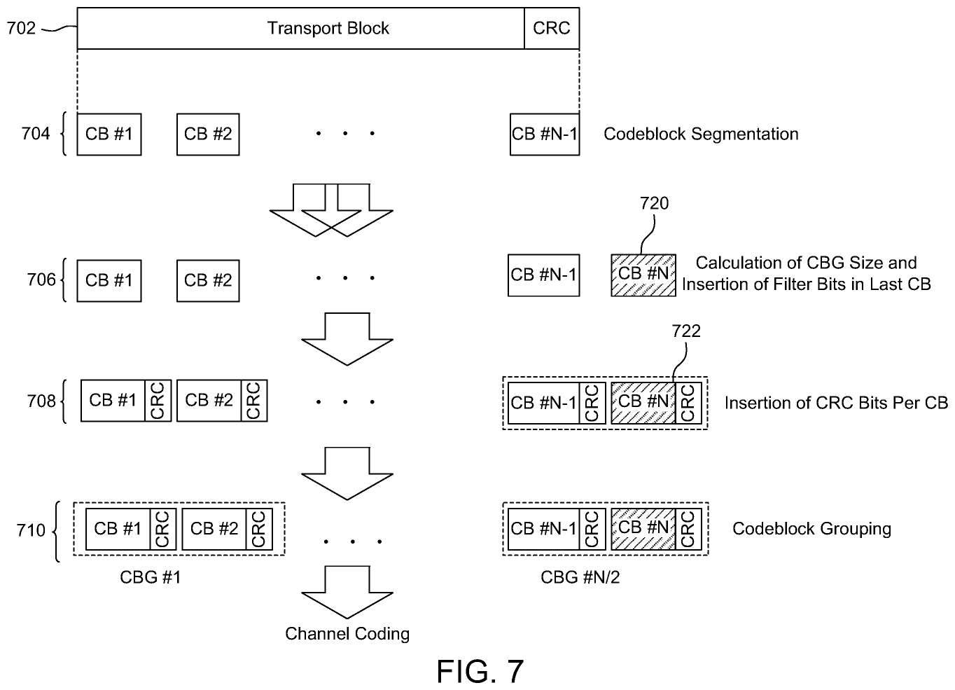

CBG sizing may result in the last CBG having less CBs compared to previous CBGs of the same TB. However, as shown in FIG. 7, this can be resolved by inserting filler CBs either at the start or the end of the transport block. FIG. 7 is a diagram illustrating an example code block segmentation, filler insertion, CRC insertion and CB grouping.

As shown in FIG. 7, at 704, the network segments the CBs in transport block 702. Next, at 706, the network inserts biller bits into the last CB 720. At 708, CRC bits are added to each CB, including the CB 720. At 710, the CBs are grouped.

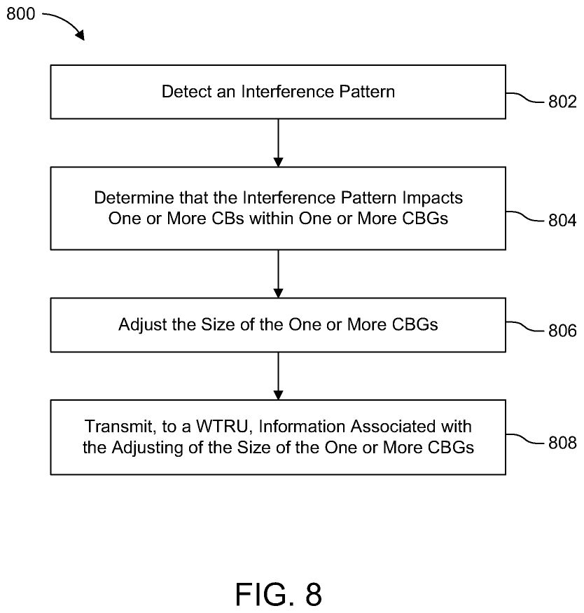

FIG. 8. illustrates an example process 800 for CBG sizing. At 802, the base station may detect an interference pattern. The interference pattern may be caused by RADAR. At 804, the base station may determine that the interference pattern impacts one or more CBs that are within one or more CBGs. For example, as shown in FIG. 5. in a situation where there are two CBGs (each with four CBs), each of the two CBGs may have one CB that is impacted by interference. In another example, as shown in FIG. 6, there may be eight CBGs (each with one CB), where four CBs are impacted by interference. At 806, the base station may adjust the size of the one or more CBGs. In one embodiment, the adjustment may involve decreasing the size of each CBG (as shown in FIG. 5). In another embodiment, the adjustment may involve increasing the size of each CGB (as shown in FIG. 6). At 808, the base station may transmit, to the WTRU, information associated with the adjustment of the one or more CBGs.

As described below, the network may indicate a change in CBG sizing to the WTRU either statically, semi-dynamically, or dynamically.

In one embodiment, the network may communicate whether it uses static CBG sizing or not to emerging UEs via MIB message.

In a static approach, the network may utilize the spare bit in MIB message to indicate whether it uses CBG sizing or not to emerging UEs. This spare bit may be referred to as “staticCbgSizing”. A bit value set to “0” may indicates legacy CBG behavior (i.e., the number of CBs depend on the initial transmission). A bit value set to “1” may indicate a one CB per CBG HARQ configuration.

When staticCbgSizing is enabled, connected WTRUs may continue to use legacy CBG sizing unless a new MIB is received. On the other hand, emerging WTRUs may assume that an interferer is present and that all transmitted CBGs consist of only one CB. The emerging WTRUs may continue to use this assumption as long as they are connected to the network and until a new MIB with staticCbgSizing set to “0” is received.

The network may utilize the spare bit in MIB to indicate whether it uses static CBG sizing. For example, as described above, a bit value of “0” may indicate legacy CBG behavior while a bit value of “1” may indicate one code block per code block group. This approach may be utilized when a short pulse interference signal is present that may impact a single CB (e.g., RADAR signal). The MIB message below may be used by the network to communicate to emerging WTRUs as to whether it uses static CBG sizing.

MIB ::= SEQUENCE {

| | |
|---|---|
| systemFrameNumber | BIT STRING (SIZE (6)), |
| subCarrierSpacingCommon | ENUMERATED {scs15or60, |

scs30or120},

| | |
|---|---|
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| → staticCbgSizing | BIT STRING (SIZE (1)) |

}

When staticCbgSizing is enabled (i.e., set to “1”), connected WTRUs may continue to use legacy CBG sizing. However, emerging WTRUs may assume a narrow band interferer is present and that all transmitted CBGs consist of only one CB. The emerging WTRUs may continue to use this assumption as long as they are connected to the network and until they read a new MIB with staticCbgSizing set to “0”.

Further, the WTRU may inform the network of its static CBG sizing supportability. The network may optionally enable or disable this feature for the WTRU based on the WTRU capability and network's requirement. The WTRU may inform the network of its capability via the information message shown in Table 5 below.

TABLE 5
Static CBG Sizing Supportability

| | | | FDD-TDD | FR1-FR2 |
|---|---|---|---|---|
| Definitions for Parameters | Per | M | DIFF | DIFF |
| StaticCbgSizingSupport | WTRU | Yes | No | No |
| Indicates whether the WTRU | | | | |
| may support reading CB | | | | |
| information in MIB | | | | |

If a WTRU indicates that it does not support static CBG sizing, the network may use legacy behavior for all CBGs transmitted to that WTRU.

In another embodiment, the network may configure the WTRU to periodically apply a different CBG size for a certain duration based on current interference characteristics. In this embodiment, CBG sizing is configured semi-dynamically at the WTRU via RRC reconfiguration messages.

New Information Elements are proposed to indicate the number of CBs per CBG, the duration of the CBG sizing ON/OFF cycle, the duration of ON period in slots, the duration in slots after RRC Reconfiguration message to start the CBG sizing cycle, and the consecutive number of slots the WTRU will follow the CBG sizing cycle. After the expiration of the CBG sizing duration, the WTRU reverts to legacy behavior, which assumes that retransmissions have the same CBG size as the initial transmission.

A RRC reconfiguration message that may contain parameters to support semi-dynamic CBG sizing is shown in bold below.

PDSCH-ServingCellConfig ::= SEQUENCE {

| | |
|---|---|
| code blockGroupTransmission | SetupRelease { PDSCH-Code |

blockGroupTransmission } OPTIONAL,

| | |
|---|---|
| xOverhead | ENUMERATED { xOh6, xOh12, xOh18 } |

OPTIONAL, -- Need S

| | |
|---|---|
| nrofHARQ-ProcessesForPDSCH | ENUMERATED {n2, n4, n6, n10, n12, |

n16} OPTIONAL, -- Need S

| | |
|---|---|
| pucch-Cell | ServCellIndex OPTIONAL , -- Cond |

```
  SCellAddOnly
  ...
}
PDSCH-Code blockGroupTransmission ::= SEQUENCE {
    maxCodeblockGroupsPerTransportBlock ENUMERATED {n2, n4, n6, n8},
```

| | |
|---|---|
| nrofCbsPerCbg | INTEGER (0..335) |
| CbgSizingCycle | ENUMERATED {1, 2, 3, 4, 5, 6, 8, 10, |

20, 30, 40, 50, 60,...}

| | |
|---|---|
| CbgSizingonDurationTimer | ENUMERATED {1, 2, 3, 4, |

```
    5, 6, 8, 10, 20, 30, 40, 50, 60,...}
    CbgSizingStartOffset
```

| | |
|---|---|
| ms10 | INTEGER(0..9), |
| CbgSizingTimer | ENUMERATED {0, 1, 2, 3, 4, 5, 6, 8, |

10, 20, 30, 40, 50, 60,...}

| | |
|---|---|
| code blockGroupFlushIndicator | BOOLEAN, |

...
}

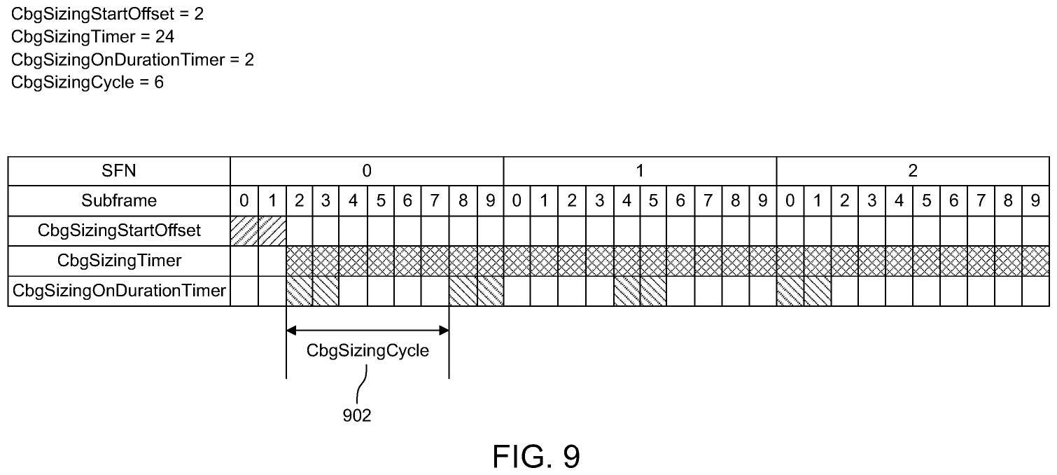

FIG. 9 illustrates an example of an RRC configured CBG sizing. In FIG. 9, the following parameters are defined: CbgSizingStartOffset, CbgSizingTimer, CbgSizingOnDurationTimer, and CbgSizingCycle.

CbgSizingCycle may define the duration of one “CBG sizing ON time” and one “CBG sizing OFF time” in slots. CbgSizingOnDurationTimer may define the duration of “CBG sizing ON time” in slots within one CBGSizingCycle. CbgSizingStartOffset may define the duration in slots after the RRC reconfiguration message to start CbgSizingCycle. CbgSizingTimer may define the consecutive number of slots the WTRU shall follow the CBG sizing cycle after CbgSizingStartOffset.

As shown in FIG. 9, semi-dynamic CBG sizing 902 may start after 2 slots and continue for the next 24 slots. The CBG sizing 902 cycles may be 6 slots in length with an “on duration” of 2 slots. During the period that CBGSizingOnDuration is on, the WTRU may use “nrofCbsPerCbg” as the default CBG size. After the expiration of the CbgSizingTimer, the WTRU may revert to legacy behavior, which assumes that retransmissions have the same CBG size as the initial transmission.

The WTRU may need to inform the network as to whether is supports semi-dynamic CBG sizing. The network may optionally enable or disable this feature for the WTRU based on the WTRU capability and network's requirement. The WTRU may inform the network of its capability via the information message shown in Table 6 below.

TABLE 6
Semi-dynamic CBG Sizing Supportability

| | | | FDD-TDD | FR1-FR2 |
|---|---|---|---|---|
| Definitions for Parameters | Per | M | DIFF | DIFF |
| SemidynamicCbgSizingSupport | WTRU | Yes | No | No |
| Indicates whether the WTRU | | | | |
| may support reading CB | | | | |
| information in RRC | | | | |
| Reconfiguration Message | | | | |

In one embodiment, fully dynamic CBG sizing may occur via DCI. A new DCI parameter, “CB transmission information,” may indicate the number of CBs in the CBGs. The network may dynamically change the CBG size via DCI to adapt to the varying characteristics of the RADAR interference.

The CBG would be dynamically resized such that the RADAR signal is fitted within a single CBG of minimum size, thus reducing the number of CB retransmissions. Each (re)-transmission would follow a CBG sizing indicated by its corresponding DCI message. If this parameter is not configured, the WTRU may follow legacy HARQ behavior (i.e., retransmission have the same CBG size as the initial transmission.

As shown below, the RRC reconfiguration message may indicates the maximum code block groups per transport block.

PDSCH-ServingCellConfig ::= SEQUENCE {

| | |
|---|---|
| code blockGroupTransmission | SetupRelease { PDSCH-Code |

blockGroupTransmission } OPTIONAL,

| | |
|---|---|
| xOverhead | ENUMERATED { xOh6, xOh12, xOh18 } |

OPTIONAL, -- Need S

| | |
|---|---|
| nrofHARQ-ProcessesForPDSCH | ENUMERATED {n2, n4, n6, n10, n12, |

n16} OPTIONAL, -- Need S

| | |
|---|---|
| pucch-Cell | ServCellIndex OPTIONAL , -- Cond |

```
  SCellAddOnly
  ...
}
PDSCH-Code blockGroupTransmission ::= SEQUENCE {
    maxCodeblockGroupsPerTransportBlock ENUMERATED {n2, n4, n6, n8},
```

| | |
|---|---|
| code blockGroupFlushIndicator | BOOLEAN, |

...
}

As shown in Table 7 below, CBG transmission information may be indicated in DCI format 0_1 and format 1_1. A new parameter “CB Transmission Information” may be added to indicate the number of CBs in the CBGs. The network may dynamically change the CBG size via DCI to adapt to the characteristics of the inferences, such as RADAR interference. Unlike the standard implementation in which CBGs of the retransmissions contain the same number of CBs as in the initial transmission of the TB, the CBG may be resized such that the interferences signal (e.g., RADAR signal) is fitted within a single CBG of minimum size, thus reducing the number of CB retransmissions.

TABLE 7
DCI Format for Scheduling PUSCH
DCI format 0_1 for Scheduling PUSCH

| Field | Bits | Comments |
|---|---|---|
| CBG Transmission Information | 0, 2, 4, | Determined by maxCode |
| | 6, 8 | blockGroupPerTransportblock |
| | | in RRC message. |
| CB Transmission Information | 9 | |

To support dynamic CBG sizing, the WTRU may report dynamic CBG sizing support as part of the FeatureSetDownlink within WTRU Capability Information message. In Table 8 below, “Yes” in the column by “FDD-TDD DIFF” and “FR1-FR2 DIFF” may indicate that the WTRU capability field can have a different value between FDD and TDD or between FR1 and FR2 and “No” may indicate if it cannot. “Yes” in the column “M” may indicate that the associated feature is mandatory and “No” may indicate that the associated feature is optional. The Per column may indicates the level the associated parameter is included. For example, “WTRU” in the “Per” column may indicate that the associated parameter is signaled per WTRU.

If the WTRU is not capable of supporting this feature (i.e., reading the CB transmission information field in DCI), the base station may continue to transmit legacy DCI formats to the WTRU. If the WTRU is capable of supporting this feature, it would indicate that as part of its WTRU capability report and start reading new DCI format.

TABLE 8
DynamicCbgSizing Support

| | | | FDD-TDD | FR1-FR2 |
|---|---|---|---|---|
| Definitions for Parameters | Per | M | DIFF | DIFF |
| DynamicCbgSizing Support | WTRU | Yes | No | No |
| Indicates whether the WTRU | | | | |
| may support reading CB | | | | |
| information in DCI | | | | |

If WTRUs in the network can support dynamic CBG sizing, the WTRUs may assume dynamic CBG sizing to be the default configuration without the need to use the spare bit in MIB. In this case, the WTRUs may directly use dynamic information provided by the new DCI to determine the number of CBGs and the size of the CBGs on a per-retransmission basis.

As explained in above, if a WTRU is configured to receive CBG based transmissions, i.e., received higher layer parameter codeBlockGroupTransmission, for PDSCH.

For initial transmission of a TB as indicated by the New Data Indicator field of the scheduling DCI, the WTRU may assume that all the code block groups are present. For a retransmission of a TB as indicated by the New Data Indicator field of the scheduling DCI, the WTRU may assume that the CBGTI field of the scheduling DCI indicates which CBGs of the TB are present in the transmission.

A bit value of “0” in the CBGTI field may indicate that the corresponding CBG is not transmitted and 1′ indicates that it is transmitted. If the CBG flushing out information (CBGFI) field of the scheduling DCI is present, CBGFI may be set to “0” and indicate that the earlier received instances of the same CBGs being transmitted may be corrupted. A CBGFI set to “1” may indicate that the CBGs being retransmitted are combinable with the earlier received instances of the same CBGs.

A CBG does not necessarily need to contain the same number of CBs as in the initial transmission of the transport block. The WTRU may read field “CB transmission information” of the scheduling DCI to determine the size of the transmitted CBGs. After determining which CBG is transmitted via CBG transmission information, the WTRU reads the CB transmission information to determine the size of the CBGs.

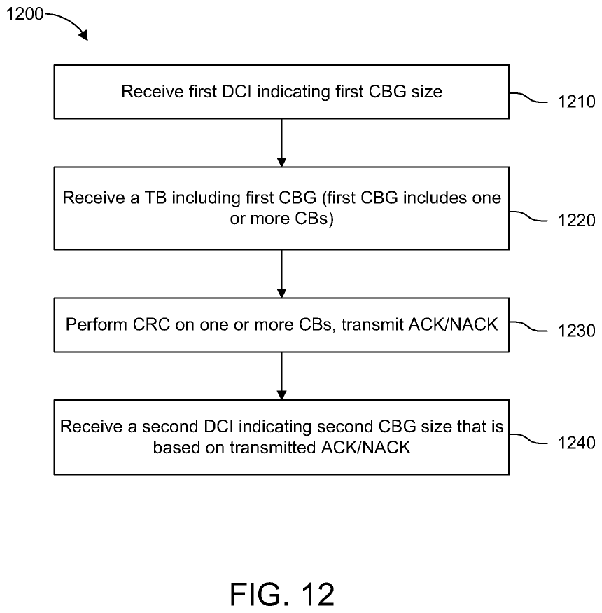

FIG. 12 is a diagram illustrating an example process 1200 of CBG sizing based on WTRU feedback. At 1210, a WTRU may receive a first DCI, from a base station, a first DCI that indicates a first CBG size. At 1220, the WTRU may receive a TB that includes one or more CBGs. The one or more CBGs may include one or more CBs. At 1230, the WTRU may perform a cyclic redundancy check (CRC) on the received TB, including the one or more CBs. At 1240, the WTRU may receive, from the base station, a second DCI that indicates a second CBG size. The second CBG size may be based on the transmitted feedback. The WTRU may then receive, from the base station, transmissions according to the second CBG size.

The transmitted feedback may be an acknowledgement (ACK) or a negative acknowledgement (NACK). If the WTRU transmits an ACK, the second CBG size may be larger than the first CBG size. If the WTRU transmits a NACK, the second CBG size may be smaller than the first CBG size.

In another embodiment, CB and CBG interleaving may be used to mitigate the impact of burst errors caused by interference (e.g., RADAR interference). With interleaving, CBs and CBGs may be arranged within the same transport block before being transmitted over the wireless channel. The arrangement happens in such a way that some CBGs can be transmitted during the interferer's “quiet period”.

FIG. 10 illustrates an example of the impact of interference with no CB/CBG interleaving. The transport block 902 includes four CBGs—CBG #1 1004, CBG #2 1006, CBG #3 1008, and CBG #4 1010. CBG #1 1004 includes CB #1 1011 and CB #2 1012. CBG #2 1006 includes CB #3 1013 and CB #4 1014. CBG #3 1008 includes CB #5 1015 and CB #6 1016. CBG #4 1010 includes CB #7 1017 and CB #8 1018. The interference signal interferes with CB #2 1012, CB #3 1013, CB #6 1016 and CB #7 1017. As shown in FIG. 10, without interleaving, all CBGs will need to be retransmitted as at least one CB within each CBG is erroneously received.

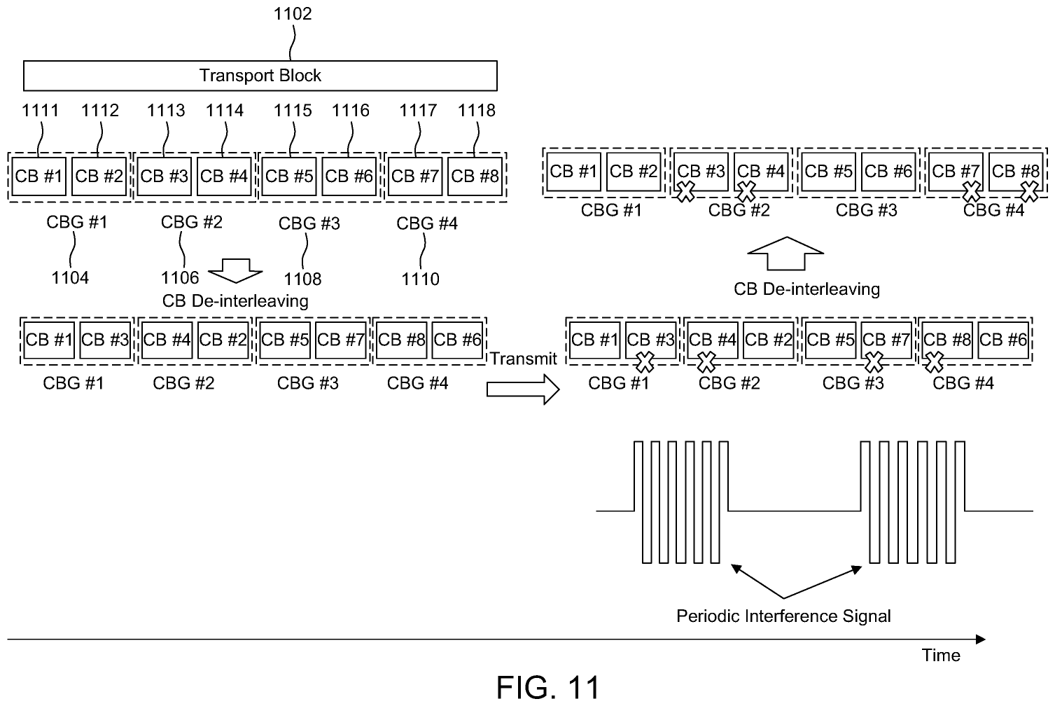

FIG. 11 illustrates example of CB/CBG interleaving. Similar to transport block 1002 in FIG. 10, transport block 1102 includes CBG #1 1104, CBG #2 1106, CBG #3 1108, and CBG #4 1110. CBG #1 1104 includes CB #1 1111 and CB #2 1112. CBG #2 1106 includes CB #3 1113 and CB #4 1114. CBG #3 1108 includes CB #5 1115 and CB #6 1116. CBG #4 1110 includes CB #7 1117 and CB #8 1118.

After CB interleaving, CBG #1 1104 includes CB #1 1111 and CB #3 1113, CBG #2 1106 includes CB #4 1114 and CB #2 1112, CBG #3 1108 includes CB #5 1115 and CB #7 1117, and CBG #4 1110 includes CB #8 1118 and CB #6 1116. As shown in FIG. 10, the transmitter manages to transmit CBG #1 1104 and CBG #3 1108 within the interferer's silent period. Consequently, CBG #1 1104 and CBG #3 1108 are received without error and will not need to be re-transmitted.

The network may signal its use of CB/CBG interleaving to the WTRU via MIB message. The network may use the spare bit in the MIB to indicate the activation/deactivation of this feature (e.g., “0” to deactivate CB/CBG interleaving and “1” to activate CB/CBG interleaving). As shown below, the network may use a simple form of interleaving such as the odd-even pattern. In the odd-even interleaver, the first CBG may contain the first N odd CBs, the second CBG contains the first N even CBs, the third CBG contains the second N odd CBs, the forth CBG contains the second N even CBs, and so on.

| MIB ::= SEQUENCE { | |
|---|---|
| systemFrameNumber | BIT STRING (SIZE (6)), |
| subCarrierSpacingCommon | ENUMERATED {scs15or60, |
| scs30or120}, | |
| ssb-SubcarrierOffset | INTEGER (0..15), |
| dmrs-TypeA-Position | ENUMERATED {pos2, pos3}, |
| pdcch-ConfigSIB1 | INTEGER (0..255), |
| cellBarred | ENUMERATED {barred, notBarred}, |
| intraFreqReselection | ENUMERATED {allowed, notAllowed}, |
| → cb-cbgInterleaving | BIT STRING (SIZE (1)) |

}

The WTRU implementation may support CB/CBG interleaving by reading MIB parameter cb-CbgInterleaving. The impact of this solution is more prominent in emerging UEs, after CB/CBG interleaving is activated. However, connected UEs may suffer excessive BLER which may require them to drop and re-connect to the network, hence acquiring a new MIB with cb-CbgInterlaving bit set to “1”. The odd-even de-interleaver at the WTRU may regroup the CBs such that the first CBG contains the first N CBs of the first N CBGs, the second CBG contains the second N CBs of the first N CBGs, the third CBG contains the second N CBs of the second N CBGs, the fourth CBG contains the second N CBs of the second N CBGs, and so on.

Dynamic CBG sizing may allow the transmitter to dynamically change the size of the CBG based on knowledge of the interference pattern. The operation may entail the following: (1) the gNB may analyze the interference pattern or an external node sends information characterizing the operation of the interferer to the gNB; (2) the gNB may utilize this information to determine the code blocks that may be impacted by the interference; and (3) the gNB may make dynamic decisions on whether to increase or decrease the size of the CBG to optimize HARQ feedback and amount of data retransmitted.

CB and CBG interleaving may scramble the locations of the CBs and CBGs based on interference pattern knowledge. The scramble operation may entail the following: (1) the gNB may analyze the interference pattern or an external node sends information characterizing the operation of the interferer to the gNB; (2) the gNB may utilize this information to determine the interferer's silent periods; and (3) the gNB may make dynamic decisions on how to interleave CBs and CBGs such that CBs of a certain CBG fall within those silent periods.

The detected interference patterns (e.g., RADAR interference patters) may be measured by the base station and/or external sensors. Further, the detected interference patterns may be based on feedback from one or more WTRUs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a wireless transmit/receive unit (WTRU), the method comprising:
receiving, from a base station, a first downlink control information (DCI) indicating a first code block group (CBG) size;
receiving, from the base station, a transport block (TB) that includes one or more CBGs, wherein the one or more CBGs include one or more code blocks (CBs);
performing a cyclic redundancy check (CRC) on the received TB;
transmitting, to the base station, feedback based on the CRC; and
receiving, from the base station, a second DCI indicating a second CBG size, wherein the second CBG size is based on the transmitted feedback.

2. The method of claim 1, wherein, if the feedback is an acknowledgement (ACK), the second CBG size is larger than the first CBG size.

3. The method of claim 1, wherein, if the feedback is an negative acknowledgement (NACK), the second CBG size is smaller than the first CBG size.

4. A method performed by a base station, the method comprising:
detecting an interference;
determining that the interference impacts one or more code blocks (CBs) within one or more code block groups (CBGs);
adjusting a size of the one or more CBGs; and
transmitting, to a wireless transmit/receive unit (WTRU), information associated with the adjusting of the size of the one or more CBGs.

5. (canceled)

6. The method of claim 4, wherein adjusting the size of the one or more CBGs comprises increasing the number of CBs within the one or more CBGs.

7. The method of claim 4, wherein adjusting the size of the one or more CBGs comprises decreasing the number of CBs within the one or more CBGs.

8. The method of claim 4, wherein the interference impacts the same CB instance in each CBG.

9. The method of claim 4, wherein the base station detects the interference based on feedback from one or more WTRUs.

10. The method of claim 4, wherein the transmitting of the information relating to the adjusting of the size of the one or more CBGs is performed via master information block (MIB) signaling.

11. The method of claim 4, wherein the transmitting of the information relating to the adjusting of the size of the one or more CBGs is performed via radio resource control (RRC) signaling.

12. The method of claim 11, wherein the RRC signaling includes information indicating a CBG sizing duration.

13. The method of claim 4, wherein the transmitting of the information relating to the adjusting of the size of the one or more CBGs is performed via downlink control information (DCI) signaling.

14. A base station comprising:
a transmitter;
a receiver; and
a processor;
wherein the receiver and processor are configured to detect an interference;
wherein the processor is configured to:
determine that the interference pattern impacts one or more code blocks (CBs) within one or more code block groups (CBGs);
adjusting a size of the one or more CBGs; and
wherein the transmitter is configured to transmit, to a wireless transmit/receive unit (WTRU), information associated with the adjusting of the size of the one or more CBGs.

15. (canceled)

16. The base station of claim 14, wherein adjusting the size of the one or more CBGs comprises increasing the number of CBs within the one or more CBGs.

17. The base station of claim 14, wherein adjusting the size of the one or more CBGs comprises decreasing the number of CBs within the one or more CBGs.

18. The base station of claim 14, wherein the interference impacts the same CB instance in each CBG.

19. The base station of claim 14, wherein the processor detects the interference based on feedback from one or more WTRUs.

20. The base station of claim 14, wherein the transmitting of the information relating to the adjusting of the size of the one or more CBGs is performed via master information block (MIB) signaling.

21. The base station of claim 14, wherein the transmitting of the information relating to the adjusting of the size of the one or more CBGs is performed via radio resource control (RRC) signaling.

22. (canceled)

23. The base station of claim 14, wherein the transmitting of the information relating to the adjusting of the size of the one or more CBGs is performed via downlink control information (DCI) signaling.
